(19) United States
(12) Patent Application Publication
(10) Pub. No.: US 2023/0091752 A1
(43) Pub. Date: Mar. 23, 2023

(54) VIBRATING BUILD MATERIAL DISTRIBUTORS

(71) Applicant: HEWLETT-PACKARD DEVELOPMENT COMPANY, L.P., Spring, TX (US)

(72) Inventors: David R. Otis, Jr., Corvallis, OR (US); Kevin E. Swier, Corvallis, OR (US); Michael G. Monroe, Corvallis, OR (US); Daniel Mosher, Corvallis, OR (US); Douglas Pederson, Corvallis, OR (US)

(21) Appl. No.: 17/802,832

(22) PCT Filed: Jul. 28, 2020
(86) PCT No.: PCT/US2020/043840

§ 371 Date: Aug. 26, 2022

(51) Int. Cl. B29C 64/214; B33Y 10/00; B33Y 30/00; B29C 64/141; B29C 64/165; B29C 64/393; B33Y 50/02

(52) U.S. Cl. CPC B29C 64/214; B33Y 10/00; B33Y 30/00; B29C 64/141; B29C 64/165; B29C 64/393; B33Y 50/02

(57) ABSTRACT

A 3D printer is disclosed herein. The 3D printer comprises a build material distributor to generate layers of a build material in a spreading direction along a spreading axis; a resonator mounted on the build material distributor to vibrate the build material distributor along the spreading axis at a frequency; and a controller. The controller is to control the resonator to vibrate the build material distributor at the frequency while controlling the build material distributor to spread a volume of build material over a platform to generate a layer of build material.

### BACKGROUND

Some additive manufacturing or three-dimensional printing systems generate 3D objects by selectively solidifying portions of successively formed layers of build material on a layer-by-layer basis. The build material which has not been solidified is then separated from the 3D objects.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a 3D printer to generate a layer of build material;

FIG. 2 is a flowchart of an example method of generating a layer of build material in a 3D printer;

FIG. 3 is a schematic diagram showing an example of a build material distributor comprising a plurality of resonators;

FIG. 4 is a flowchart of another example method of generating a layer of build material in a 3D printer; and

FIG. 5 is a block diagram showing a processor-based system example of a 3D printer that is to generate a layer of build material.

### DETAILED DESCRIPTION

The following description is directed to various examples of additive manufacturing, or three-dimensional printing, apparatus and processes involved in the generation of 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As used herein, the term “about” is used to provide flexibility to a range endpoint by providing that a given value may be, for example, an additional 15% more or an additional 15% less than the endpoints of the range. In another example, the range endpoint may be an additional 30% more or an additional 30% less than the endpoints of the range. The degree of flexibility of this term can be dictated by the particular variable and would be within the knowledge of those skilled in the art to determine based on experience and the associated description herein.

For simplicity, it is to be understood that in the present disclosure, elements with the same reference numerals in different figures may be structurally the same and may perform the same functionality.

3D printers generate 3D objects based on data in a 3D model of an object or objects to be generated, for example, using a CAD computer program product. 3D printers may generate 3D objects by selectively processing layers of build material. For example, a 3D printer may selectively treat portions of a layer of build material, e.g. a powder, corresponding to a layer of a 3D object to be generated, thereby leaving the portions of the layer un-treated in the areas where no 3D object is to be generated. The combination of the generated 3D objects and the un-treated build material may also be referred to as a build volume. The volume in which the build volume is generated may be referred to as a build chamber.

3D printers may selectively treat portions of a layer of build material by, for example, ejecting a printing liquid in a pattern corresponding to the 3D object. Examples of printing liquids may include fusing agents, detailing agents, curable binder agents or any printing liquid suitable for the generation of a 3D object. Other 3D printers may selectively treat portions of the layer of build material by, for example, using a focused energy source (e.g., laser, solid state emitter) to the portions of the layer of build material to be solidified.

Some 3D printers use fusing agents to treat the portions of the layer of build material. The portions in which the fusing agent is applied are further heated so that the fusing agent absorbs such energy to heat up and melt, coalesce and solidify upon cooling the portions of build material in which the fusing agent was ejected thereto. The three-dimensional printing system may heat the build material by applying energy from an energy source to each layer of build material.

Some three-dimensional printing systems use a thermally curable binder agent which has to be heated to a predetermined temperature to cause components of the liquid binder agent to bind together particles of build material on which it is applied. Such a liquid binder agent may comprise, for example, latex particles and curing of the binder may occur, for example, at a temperature above 100 degrees Celsius, or above 120 degrees Celsius, or above 150 degrees Celsius.

Suitable powder-based build materials for use in additive manufacturing include polymer powder, metal powder or ceramic powder. In some examples, non-powdered build materials may be used such as gels, pastes, and slurries.

As mentioned above, 3D printers generate layers of build material. Some 3D printers generate the layers of build material by spreading an amount of build material on a build platform or on a previously generated build material layer. Some spreading mechanisms do not sufficiently compact the build material in the build material layer thereby leading to the generation of layers having a relatively low density. Furthermore, some spreading mechanisms are not able to generate highly uniform build material layers, for example layer thickness may be not uniform. The build material particles of these layers tend to separate from the build material layer and become airborne as a result of, for example, the airflows generated within the build chamber. Airborne build material may, for example, clog nozzles from the printheads, settle on moveable mechanical elements, and generate clouds of build material which obstruct the view of some sensors (e.g., optical sensors, thermal cameras). Airborne particles of some types of build materials may be explosive under certain atmospheric conditions. Furthermore, the contact of a jetted printed agent on a build material layer disturbs and displaces build material particles from such layers

Examples described here provide a spreading mechanism that is able to generate high-density and uniform thickness layers which has been shown to lead to the generation of 3D objects with higher part accuracy and better mechanical properties.

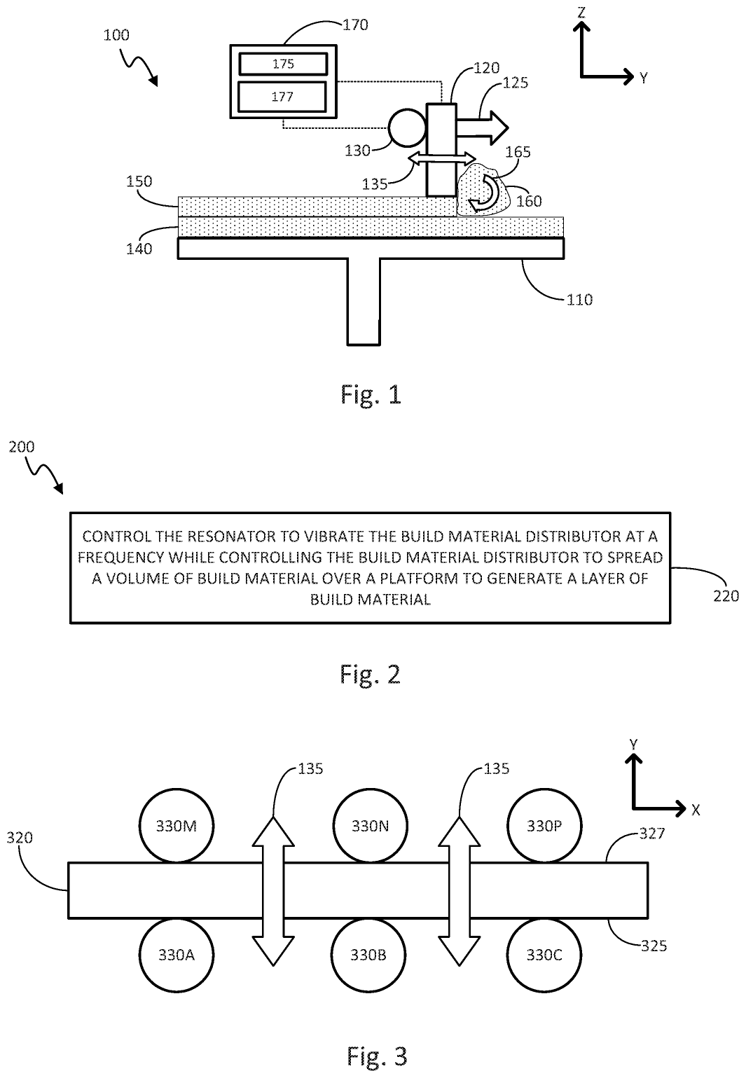

Referring now to the drawings, FIG. 1 is a schematic diagram showing an example of a side-view of elements of a 3D printer 100 to generate a layer of build material 150.

The 3D printer comprises a platform 110 that is moveable along a vertical axis (i.e., illustrated axis Z), on which build material layers are generated. In other examples, the platform 110 is part of an external module (not shown) that is attachable to the 3D printer 100 for the generation of a 3D object. In some examples, the platform 110 is controlled in such a way that prior to the generation of a build material layer, the platform 110 is moved vertically downwardly for a distance corresponding to the thickness of the build material layer to be generated, for example 30 microns, 50 microns, 80 microns or 120 microns.

The 3D printer 100 comprises a build material distributor 120 that is to generate build material layers 140-150 by spreading a build material volume 160 in a spreading direction 125 on the platform 110. The spreading direction 125 may be a direction along a spreading axis (i.e., illustrated axis X) comprised in a horizontal plane parallel to the surface of the platform 110. In an example, the build material distributor 120 is a blade. In an example, the blade may be made of stainless steel and/or aluminum and may have a thickness between 1.5 to 8 mm, for example, 2 or 6.4 mm. In another example, the blade is made of another material, such as a polymeric material. Some examples of the 3D printer 100 are designed in such a way that the build material distributor 120 may generate layers bidirectionally along the y-axis. Other examples of the 3D printer 100 may generate layers unidirectionally along the y-axis (e.g., in a single direction along the spreading axis). In an example, the build material distributor 120 may spread the build material volume 160 at a speed from the range of about 1 to about 12 inches per second (ips). In another example, the build material distributor may spread the build material volume 160 at a speed from the range of about 3 to about 10 ips.

The 3D printer 100 further comprises a resonator 130 mounted on the build material distributor 120 to vibrate the build material distributor 120 along the spreading axis (e.g., axis Y) at an ultrasonic frequency. The build material distributor 120 vibration is illustrated with reference to element 135. In an example, the resonator 130 may be implemented as a piezoelectrical crystal pair that expands upon the application of an electrical voltage, thereby generating the vibration. In some examples, the resonator 130 vibrates the build material distributor 120 in a single axis (i.e., axis Y). In other examples, the vibration 135 of the build material distributor 120 caused by the resonator 130 may further comprise a vertical component (i.e., axis Z).

Vibrating along the spreading axis causes a portion of the volume of build material 160 to fluidize, as indicated by arrow 165, as the build material distributor 120 spreads the volume of build material 160 to generate the layer of build material 150. Other vibrations, for example, vertical vibrations have been shown not fluidize the volume of build material 160 as effectively. The fluidization of the portion of build material 160 is dependent on the applied vibration 135 providing enough energy to overcome the surface cohesion energy between build material particles of the volume of build material 160 and the portion of the build material distributor 120 in contact therewith.

The 3D printer 100 further comprises a controller 170. The controller 170 comprises a processor 175 and a memory 177 with specific control instructions to be executed by the processor 175. The functionality of the controller 170 is described further below with reference to FIG. 2.

In the examples herein, the controller 170 may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller 170 may be, at least partially, implemented in the form of an electronic circuitry. The controller 170 may be a distributed controller, a plurality of controllers, and the like.

FIG. 2 is a flowchart of an example method 200 of generating a layer of build material in a 3D printer. In some examples, the method 200 may be executed by a controller such as the controller 170 from FIG. 1. The method 200 may comprise previously disclosed elements from FIG. 1 referred to with the same reference numerals.

Method 200 may start when a build material distribution module (not shown) supplies a volume of build material 160 to be spread to the build material distributor 120. The build material distribution module may be implemented in a number of different ways, for example an overhead hopper, an Archimedes screw or a raising platform. The build material distribution module may be controlled by the same controller that executes method 200 or by a different controller.

At block 220, the controller 170 controls the resonator 130 to vibrate 135 the build material distributor 120 at an ultrasonic frequency while controlling the build material distributor 120 to spread the volume of build material 160 over the platform 110 to generate a layer of build material 150. In the examples herein, the range of ultrasonic vibration is above 20 kHz. In some examples, the layer of build material may be the first layer of build material to be generated on the build platform 110 (e.g., layer 140). In other examples, the layer of build material may be generated on a previously generated layer (e.g., layer 150).

The controller 170 may control the resonator 130 to vibrate 135 in a number of different ways, for example, in a fixed frequency or sweeping over a range of frequencies between a first lower frequency and a second higher frequency. In an example, the sweep of frequencies may be a linear sweep generated through a sinusoidal wave input signal. In another example, the sweep of frequencies may be a stepped sweep of discrete frequencies generated through a square wave input signal.

For example, the controller 170 may control the resonator 130 to vibrate the build material distributor 120 through a range of frequencies between a first lower frequency of about 30 kHz and a second higher frequency of about 95 kHz. It is to be understood that in additional examples, the controller 170 may control the resonator 130 to vibrate at non-ultrasonic or lower ultrasonic frequencies such as frequencies lower than 25 kHz, and higher non-ultrasonic frequencies such as frequencies above 20 kHz (e.g., 100 kHz).

The controller 170 may also control the duration of the sweep through the range of frequencies. In some examples, the controller 170 may control the resonator 130 to vibrate the build material distributor 120 to sweep through a range of frequencies from a first lower frequency to a second higher frequency during a period defined from about 1 ms to about 5 ms; for example, 1 ms, 1.5 ms, 2 ms, 2.5 ms, 3 ms, 3.5 ms, 4 ms, 4.5 ms, or 5 ms. In other examples, the sweep through the range of frequencies may be controlled to last longer than 5 ms.

The controller 170 may also control the resonator 130 to vibrate the build material distributor 120 at an amplitude (e.g., vibration displacement distance along the spreading axis) of the range of about 1 um to about 4 um, for example, 1 um, 2 um, 3 um or 4 um. In other examples, however, the controller 170 may control the resonator 130 to vibrate the build material distributor 120 at higher amplitudes, such as 10 um or 20 um.

As mentioned above, in some examples, the build material distributor 120 may be implemented as a blade. In some examples, the blade may not be completely rigid and, therefore deforms upon the application of vibration 135 caused by the resonator 130. The deformation behavior may be understood with Hooke's law.

In some examples, the controller 170 may control the resonator 130 to vibrate at a frequency and amplitude based on a Weber particle number calculation relating to a characteristic of a build material to be used to form the layers. The Weber particle number is a ratio used in fluid mechanics to compare the relative importance of inertia and surface tension (or kinetic energy to surface energy). Additionally, or alternatively, the controller 170 may also control the resonator 130 to vibrate based on the type of build material to be spread and the build material distributor.

The Weber particle number calculation may be based on different parameters. The Weber particle number calculation may be based on the sphericity (S) of the build material particles, which indicates how spherical the build material particles to be spread are on average (e.g., S=1 for a perfect sphere, 0<S<1 for less-than-perfect sphere). Powders generated using gas atomization may have a sphericity from the range of about 0.6 to about 0.95; those generated using water atomization may have a sphericity from the range of about 0.4 to about 0.6. The Weber particle number calculation may be also based on the build material particle density; for example, aluminum (2,700 kg/m³), steel (for example, around 8,050 kg/m³), copper (8,950 kg/m³), tungsten (19,250 kg/m³) and polymer powders (for example, around 1,000 kg/m³). The Weber particle number calculation may be also based on the average radius of the build material particles in a given build material; for example, the 50^{th} percentile for metal particles based on count may range from about 1 um to about 10 um diameter, the 50^{th} percentile for ceramic particles based on count may be around 0.5 um diameter, and the 50^{th} percentile for polymeric particles based may be up around 30 um. The Weber particle number calculation may be also based on the material surface energy. The material surface energy, or surface tension, is a force per unit length (e.g., measured in N/m) or an energy per unit area (e.g., measured in J/m²) that indicates the threshold force or energy to separate two objects which are in contact, e.g., a build material distributor and a build material particle. The value of the surface energy may be based on the temperature, for example, 50-80 degrees Celsius which is an example of spreading temperature.

In some examples the Weber particle number may be calculated using the following formula; where S is the sphericity of the build material particles, ρ is the build material particle density, R is the radius of the build material particles (e.g., the 50^{th} percentile), y₀ is the amplitude of the vibration, ω is the frequency of the vibration, and Γ is the material surface energy.

$$W {e}_{particle} = \frac{2 S {ρ}_{p a rticle} {{R}_{particle} ( {y}_{0} ω )}^{2}}{3 Γ}$$

It is to be noted that the formula is provided as an example and modifications of the formula may be made. It is to be understood, that these alternative calculations are also comprised in the scope of the present disclosure.

It has been tested that some Weber particle numbers, which include vibration and amplitude values, are indicative of a better spreading to generate a build material layer. The controller 170 may be encoded with a suitable and predeterminable Weber particle number value (e.g., tested Weber particle numbers indicative of better spreading) based on the type of build material to be spread. Some examples of predeterminable Weber particle number may be selected from the range defined from about 0.1 to about 1.5, for example, 0.1, 0.3, 0.5, 0.7, 0.9, 1.1, 1.3, and 1.5. Other examples may include predeterminable Weber particle numbers below 0.1 or above 1.5, for example 0.07 and 1.7 respectively. The controller may use one value of the tested Weber particle numbers to obtain the vibration or the amplitude values and control the resonator accordingly. The controller may also use for the calculation, characteristic values of the build material, such as the type of build material, and surface energy of the build material.

As mentioned above, the controller 170 is to control the resonator to vibrate at a vibration 135 based on the type of build material to be spread.

### EXAMPLE: SPREADING POWDER A AT A 3 UM AMPLITUDE VIBRATION

In this example a powder is provided, powder A, with the 50^{th} percentile powder diameter of 2.8 um, 0.9 sphericity, mass particle density of 8 g/cc, and apparent surface energy of 5 dyne/cm. For this kind of material, it has been previously determined, e.g. through testing, that the Weber number should be about 0.3. Using a 3 um amplitude of vibration, a vibration frequency of about 2 5kHz is thus determined as the ideal frequency

### EXAMPLE: SPREADING POWDER A AT A 1.5 UM AMPLITUDE VIBRATION

In this example the same powder is provided, powder A, with the 50^{th} percentile powder diameter of 2.8 um, 0.9 sphericity, mass particle density of 8 g/cc, and apparent surface energy of 5 dyne/cm. For this kind of material, it has been previously determined, e.g. through testing, that the Weber number should be about 0.3. Using a 1.5 um amplitude of vibration, a vibration frequency of about 50 kHz is thus determined as the ideal frequency. As it can be appreciated from these examples, lower frequencies may be applied to a sample of build material by vibrating the build material at higher amplitudes.

### EXAMPLE: SPREADING POWDER B AT A 3 UM AMPLITUDE VIBRATION

In this example a different powder is provided, powder B, with the 50^{th} percentile powder diameter of 1.9 um, 0.8 sphericity, mass particle density of 8.96 g/cc, and apparent surface energy of 9.5 dyne/cm. For this kind of material, it has been previously determined, e.g. through testing, that the Weber number should be about 0.3. Using a 1.5 um amplitude of vibration, a vibration frequency of about 90 kHz is thus determined as the ideal frequency

### EXAMPLE: SPREADING POWDER B AT A 1.5 UM AMPLITUDE VIBRATION

In this example the same powder is provided, powder B, with the 50^{th} percentile powder diameter of 1.9 um, 0.8 sphericity, mass particle density of 8.96 g/cc, and apparent surface energy of 9.5 dyne/cm. For this kind of material, it has been previously determined, e.g. through testing, that the Weber number should be about 0.3. Using a 3 um amplitude of vibration, a vibration frequency of about 44.5 kHz is thus determined as the ideal frequency As it can be also appreciated from the examples of powder B, lower frequencies may be applied to a sample of build material by vibrating the build material at higher amplitudes.

### EXAMPLE: SPREADING ANCOR 316L AT A 2 UM VIBRATION

In this example, the build material is Ancor 316L, or a similar type of build material, with the 50^{th} percentile powder diameter of 2.8 um, 0.8 sphericity, mass particle density of 8 g/cc, and apparent surface energy of 9.7 dyne/cm. Ancor 316L may be obtained from GKN, a UK company headquartered in Redditch, Worcestershire. For this kind of material, it has been previously determined, e.g. through testing, that the Weber number should be about 0.3. Using a 2 um amplitude of vibration, a vibration frequency of about 55.5 kHz is thus determined as the ideal frequency.

### EXAMPLE: SPREADING ANCOR 316L WITH 50^{th} AT A 10 UM AMPLITUDE VIBRATION

In this example, the build material is Ancor 316L, or a similar type of build material, with the 50^{th} percentile powder diameter of 2.8 um, 0.8 sphericity, mass particle density of 8 g/cc, and apparent surface energy of 9.7 dyne/cm. For this kind of material, it has been previously determined, e.g. through testing, that the Weber number should be about 0.3. Using a 10 um amplitude of vibration, a vibration frequency of about 11.1 kHz is thus determined as the ideal frequency. As it can be also appreciated from the examples of Ancor 316L, lower frequencies may be applied to a sample of build material by vibrating the build material at higher amplitudes.

### EXAMPLE: SPREADING ANCOR 316L WITH 50^{th} AT A 20 UM AMPLITUDE VIBRATION

In this example, the build material is Ancor 316L, or a similar type of build material, with the 50^{th} percentile powder diameter of 2.8 um, 0.8 sphericity, mass particle density of 8 g/cc, and apparent surface energy of 9.7 dyne/cm. For this kind of material, it has been previously determined, e.g. through testing, that the Weber number should be about 0.3. Using a 20 um amplitude of vibration, a vibration frequency of about 5.5 kHz is thus determined as the ideal frequency. As it can be also appreciated from these examples, the greater the amplitude, the lower frequency may be supplied to achieve similar levels of compactivity during the generation of the build material layer. However, large amplitudes may visibly mark (e.g., track) the powder and thereby render the generated 3D object not acceptable.

### EXAMPLE: SPREADING SANDVIK 316L WITH AT A 2 UM AMPLITUDE VIBRATION

In this example, the build material is Sandvik 316L, or a similar type of build material, with the 50^{th} percentile powder diameter of 1.9 um, 0.6 sphericity, mass particle density of 8 g/cc, and apparent surface energy of 5 dyne/cm. Sandvik 316L may be obtained from Sandvik, a Sweedish company headquartered in Sandviken, Sweden. For this kind of material, it has been previously determined, e.g. through testing, that the Weber number should be about 0.3. Using a 2 um amplitude of vibration, a vibration frequency of about 55.9 kHz is thus determined as the ideal frequency.

### EXAMPLE: SPREADING SANDVIK 316L WITH A 10 UM VIBRATION

In this example, the build material is Sandvik 316L, or a similar type of build material, with the 50^{th} percentile powder diameter of 1.9 um, 0.6 sphericity, mass particle density of 8 g/cc, and apparent surface energy of 5 dyne/cm. For this kind of material, it has been previously determined, e.g. through testing, that the Weber number should be about 0.3. Using a 10 um amplitude of vibration, a vibration frequency of 11.1 kHz is thus determined as the ideal frequency. As it can be also appreciated from the examples of Sandvik 316L, lower frequencies may be applied to a sample of build material by vibrating the build material at higher amplitudes.

### EXAMPLE: PA12 WITH 50^{th} PERCENTILE POWDER DIAMETER OF 30 UM

In this example, the build material is Polyamide PA12, which is a polymeric powder, or a similar type of build material, with the 50^{th} percentile powder diameter of 30 um, 0.8 sphericity, mass particle density of 1 g/cc, and apparent surface energy of 41 dyne/cm. For this kind of material, it has been previously determined, e.g. through testing, that the Weber number should be about 0.3. Using a 2 um amplitude of vibration, a vibration frequency of about 98.7 kHz is thus determined as the ideal frequency.

FIG. 3 is a schematic diagram showing a top view of an example build material distributor 320 comprising a plurality of resonators. The build material distributor 320 may comprise previously disclosed elements from FIG. 1 referred to with the same reference numerals. In some examples, the build material distributor 320 may replace the build material distributor 120 in the 3D printer 100 of FIG. 1. The build material distributor 320 may be controlled by a controller, for example, controller 170 from FIG. 1.

The build material distributor 320 is to generate build material layers (e.g., layers 140-150 of FIG. 1) by spreading a build material volume 160 in a spreading direction 125 on a platform 110.

The build material distributor 320 further comprises a first plurality of resonators 330A-330C mounted along the length of a first side 325 of the build material distributor 320. Each of the resonators 330A-330C may be the same as or similar to the resonator 130 from FIG. 1 and may be controllable by a controller (e.g., controller 170 from FIG. 1) to, for example, execute method 200 from FIG. 2. Spacing a plurality of resonators along the length of the build material distributor 320 (e.g., equidistantly) enables a homogeneous vibration along the length of the build material distributor 320, and thereby the generation of a compact and uniform build material layer.

The build material distributor 320 is to generate build material layers bidirectionally (e.g., from −Y to +Y, and from +Y to −Y), the build material distributor 320 may further comprise a second plurality of resonators 330M-330P. Each of the resonators 330M-330P may be the same as or similar to the resonator 130 from FIG. 1 and may be controllable by a controller (e.g., controller 170 from FIG. 1) to, for example, execute method 200 from FIG. 2. The second plurality of resonators 330M-330P may be mounted along the length of a second side 327 of the build material distributor 320, the second side 327 being an opposite side with respect to the first side 325. In some examples, the first plurality of resonators 330A-C and the second plurality of resonators 330M-P may be located in a symmetrical position with respect to the length of the build material distributor 320. In these examples, the controller 170 is to control the resonators 330A-C and 330M-P to vibrate in a synchronized manner to prevent wave interference between resonators. These examples configuration, may enable the build material distributor 320 to generate uniform build material layers bidirectionally, thereby generating uniform layers from when the build material distributor is moved in either direction along the y-axis.

In other examples, however, the build material distributor 320 may not comprise a second plurality of resonators 330M-330P, thereby comprising resonators at a single side.

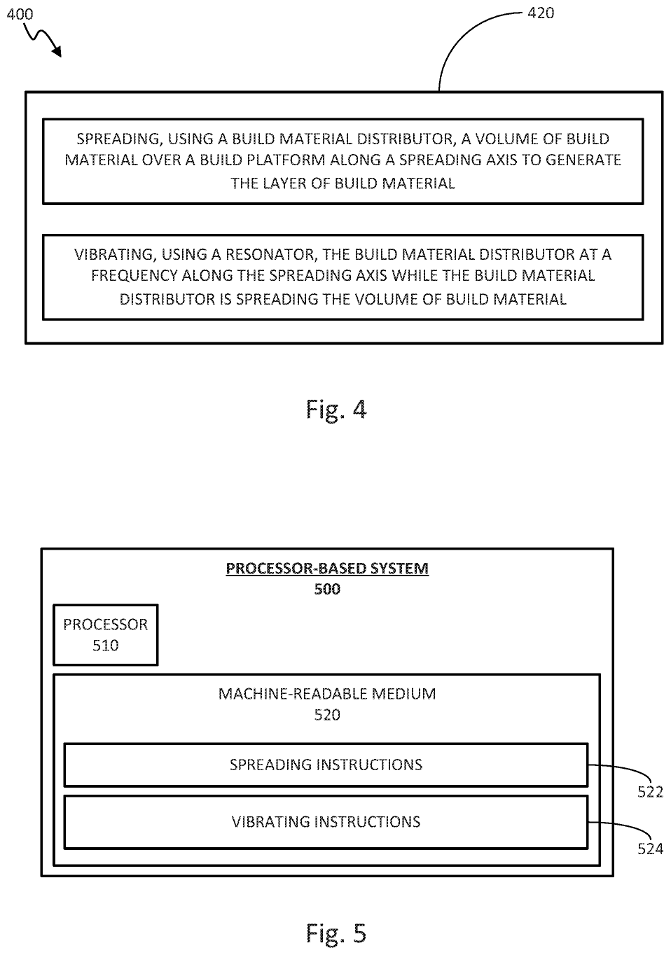

FIG. 4 is a flowchart of another example method 400 of generating a layer of build material in a 3D printer. The method 400 may involve previously disclosed elements from FIGS. 1, 2, and 3 referred to with the same reference numerals. In some examples, method 400 may be executed by the controller 170 of FIG. 1.

At block 420, the build material distributor may spread a volume of build material 160 over a build platform 110 along a spreading axis to generate a layer of build material 150. At substantially the same time, a resonator 130 may vibrate the build material distributor 120 at a frequency along the spreading axis while the build material distributor 120 is spreading the volume 160 of build material.

FIG. 5 is a block diagram showing a processor-based system 500 example of a 3D printer that is to generate a layer of build material. In some implementations, the system 500 may be or may form part of a 3D printer, such as 3D printer 100. In some implementations, the system 500 is a processor-based system and may include a processor 510 coupled to a machine-readable medium 520. The processor 510 may include a single-core processor, a multi-core processor, an application-specific integrated circuit (ASIC), a field programmable gate array (FPGA), and/or any other hardware device suitable for retrieval and/or execution of instructions from the machine-readable medium 520 (e.g., instructions 522-524) to perform functions related to various examples. Additionally, or alternatively, the processor 510 may include electronic circuitry for performing the functionality described herein, including the functionality of instructions 522-524. With respect of the executable instructions represented as boxes in FIG. 5, it should be understood that part or all of the executable instructions and/or electronic circuits included within one box may, in alternative implementations, be included in a different box shown in the figures or in a different box not shown.

The machine-readable medium 520 may be any medium suitable for storing executable instructions, such as a random-access memory (RAM), electrically erasable programmable read-only memory (EEPROM), flash memory, hard disk drives, optical disks, and the like. In some example implementations, the machine-readable medium 520 may be a tangible, non-transitory medium, where the term “non-transitory” does not encompass transitory propagating signals. The machine-readable medium 520 may be disposed within the processor-based system 500, as shown in FIG. 5, in which case the executable instructions may be deemed “installed” on the system 500. Alternatively, the machine-readable medium 520 may be a portable (e.g., external) storage medium, for example, that allows system 500 to remotely execute the instructions or download the instructions from the storage medium. In this case, the executable instructions may be part of an “installation package”. As described further herein below, the machine-readable medium may be encoded with a set of executable instructions 522-524.

Instructions 522, when executed by the processor 510, may cause the processor 510 to spread a volume of build material over a build material platform along a spreading axis to generate the layer of build material using a build material distributor. Instructions 524, when executed by the processor 510, may cause the processor 510 to vibrate the build material distributor at an ultrasonic frequency along the spreading axis while the build material distributor is spreading the volume of build material.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A 3D printer comprising:
a build material distributor to generate layers of a build material in a spreading direction along a spreading axis;
a resonator mounted on the build material distributor to vibrate the build material distributor along the spreading axis at a frequency; and
a controller to:
   control the resonator to vibrate the build material distributor at the frequency while controlling the build material distributor to spread a volume of build material over a platform to generate a layer of build material.

Feature set 2: A 3D printer with feature set 1, wherein the build material distributor is a blade.

Feature set 3: A 3D printer with any preceding feature set 1 to 2, wherein the controller is to control the resonator to vibrate the build material distributor through a range of frequencies between a first frequency and a second frequency.

Feature set 4: A 3D printer with any preceding feature set 1 to 3, wherein the controller is to control the resonator to vibrate the build material distributor between a first frequency of about 30 kHz and a second frequency of about 95 kHz.

Feature set 5:A 3D printer with any preceding feature set 1 to 4, wherein the controller is to control the resonator to vibrate the build material distributor from a first frequency to a second frequency during a period of about 1 ms to about 5 ms.

Feature set 6: A 3D printer with any preceding feature set 1 to 5, wherein the controller is to control the resonator to vibrate the build material distributor at an amplitude of the range of about 1 um to about 4 um.

Feature set 7:A 3D printer with any preceding feature set 1 to 6, further comprising a plurality of resonators mounted along the build material distributor to vibrate the build material distributor along the spreading direction at the frequency.

Feature set 8: A 3D printer with any preceding feature set 1 to 7, wherein a first subset of the plurality of resonators is mounted at a first side of the build material distributor and a second subset of the plurality of resonators is mounted on a second side of the build material distributor opposite to the first side; and wherein the controller is to control the first and the second subsets of resonators to vibrate in a synchronized manner.

Feature set 9:A 3D printer with any preceding feature set 1 to 8, wherein the controller is to control the resonator to vibrate at a vibration based on a type of build material to be spread.

Feature set 10: A 3D printer with any preceding feature set 1 to 9, wherein the controller is to control the resonator to vibrate at a vibration based on a predeterminable Weber particle number, a type of the build material, and a surface energy of the build material.

Feature set 11: A 3D printer with any preceding feature set 1 to 10, wherein the predeterminable Weber particle number is from the range of about 0.1 to about 1.5.

Feature set 12: A method to generate a layer of build material in a 3 D printer, the method comprising:
spreading, using a build material distributor, a volume of build material over a build platform along a spreading axis to generate the layer of build material; and
   vibrating, using a resonator, the build material distributor at a frequency along the spreading axis while the build material distributor is spreading the volume of build material.

Feature set 13: A method with feature set 12, further comprising vibrating the build material distributor through a range of frequencies between a first frequency and a second frequency.

Feature set 14: A method with any preceding feature set 12 to 13, further comprising vibrating the build material distributor between the first frequency of about 30 kHz and the second frequency of about 95 kHz.

Feature set 15: A non-transitory machine readable medium storing instructions executable by a processor, the non-transitory machine-readable medium comprising:
instructions to spread a volume of build material over a build platform along a spreading axis to generate the layer of build material using a build material distributor; and
instructions to vibrate the build material distributor at a frequency along the spreading axis while the build material distributor is spreading the volume of build material.

What is claimed is:

1. A 3D printer comprising:
a build material distributor to generate layers of a build material in a spreading direction along a spreading axis;
a resonator mounted on the build material distributor to vibrate the build material distributor along the spreading axis at a frequency; and
a controller to:
control the resonator to vibrate the build material distributor at the frequency while controlling the build material distributor to spread a volume of build material over a platform to generate a layer of build material.

2. The 3D printer of claim 1, wherein the build material distributor is a blade.

3. The 3D printer of claim 1, wherein the controller is to control the resonator to vibrate the build material distributor through a range of frequencies between a first frequency and a second frequency.

4. The 3D printer of claim 3, wherein the controller is to control the resonator to vibrate the build material distributor between a first frequency of about 30 kHz and a second frequency of about 95 kHz.

5. The 3D printer of claim 3, wherein the controller is to control the resonator to vibrate the build material distributor from a first frequency to a second frequency during a period of about 1 ms to about 5 ms.

6. The 3D printer of claim 1, wherein the controller is to control the resonator to vibrate the build material distributor at an amplitude in the range of about 1 um to about 4 um.

7. The 3D printer of claim 1, further comprising a plurality of resonators mounted along the build material distributor to vibrate the build material distributor along the spreading direction at the frequency.

8. The 3D printer of claim 7, wherein a first subset of the plurality of resonators is mounted at a first side of the build material distributor and a second subset of the plurality of resonators is mounted on a second side of the build material distributor opposite to the first side; and wherein the controller is to control the first and the second subsets of resonators to vibrate in a synchronized manner.

9. The 3D printer of claim 1, wherein the controller is to control the resonator to vibrate at a vibration based on a type of build material to be spread.

10. The 3D printer of claim 9, wherein the controller is to control the resonator to vibrate at a vibration based on a predeterminable Weber particle number, a type of the build material, and a surface energy of the build material.

11. The 3D printer of claim 10, wherein the predeterminable Weber particle number is from the range of about 0.1 to about 1.5.

12. A method to generate a layer of build material in a 3D printer, the method comprising:
spreading, using a build material distributor, a volume of build material over a build platform along a spreading axis to generate the layer of build material; and
vibrating, using a resonator, the build material distributor at a frequency along the spreading axis while the build material distributor is spreading the volume of build material.

13. The method of claim 12, further comprising vibrating the build material distributor through a range of frequencies between a first frequency and a second frequency.

14. The method of claim 13, further comprising vibrating the build material distributor using between the first frequency of about 30 kHz and the second frequency of about 95 kHz.

15. A non-transitory machine readable medium storing instructions executable by a processor, the non-transitory machine-readable medium comprising:
instructions to spread a volume of build material over a build platform along a spreading axis to generate the layer of build material using a build material distributor; and
instructions to vibrate the build material distributor at a frequency along the spreading axis while the build material distributor is spreading the volume of build material.
